(19) United States
(12) Patent Application Publication
(10) Pub. No.: US 2008/0273925 A1
(43) Pub. Date: Nov. 6, 2008

(54) In situ pH adjustment for soil and groundwater remediation

(76) Inventors: Robert C. Borden, Raleigh, NC (US); Jason M. Tillotson, Raleigh, NC (US); Mark Tony Lieberman, Raleigh, NC (US)

Correspondence Address: WARD AND SMITH, P.A., 1001 COLLEGE COURT, P.O. BOX 867, NEW BERN, NC, 28563-0867, US

(21) Appl. No.: 11/800,266

(22) Filed: May 4, 2007

(51) Int. Cl. B09C 1/08

(52) U.S. Cl. 405/128.5

(57) ABSTRACT

A method for increasing the pH of subsurface material, contaminated with organic and inorganic compounds is disclosed. The pH is increased by introducing a solid alkaline material formulated into a suspension where particle size, surface charge and degree of flocculation are controlled to enhance transport and distribution throughout the treatment zone.

### BACKGROUND OF THE INVENTION

1. Field of the Invention

This invention relates to the remediation of contaminated subsurface material. More specifically, the invention relates to a method of remediation of subsurface material through use of a suspension of alkaline solid material. More specifically, the invention relates to a method of adjusting the pH of subsurface material to a value which enhances remediation.

2. Description of the Related Art

There are numerous techniques employed for the remediation of contaminated subsurface material. The mechanisms for cleanup may be physical, chemical or biological. Common physical remediation methods include excavation and disposal of contaminated soil, and pumping and treatment of contaminated groundwater.

In situ treatment of contaminated subsurface material is often a less expensive approach because it eliminates the need for physical removal of the contaminated material. Common in situ treatment approaches include aerobic and anaerobic bioremediation, chemical oxidation and reduction, soil vapor extraction, air sparging, and in situ stabilization—immobilization. Most, if not all, in situ treatment processes have an optimum pH for the treatment process. Many bioremediation processes require a pH of between 6 and 8 Standard Units (SU) for optimum growth of the required microorganisms and contaminant biodegradation. Chemical oxidation, reduction and immobilization processes will also have an optimum pH. If the pH is too low, reaction rates may be reduced or the solubility of the target chemical may be too high or too low. Different remediation techniques that have been employed for various contaminants are discussed more specifically below.

It is noted that in discussing related art herein, it is often referred to in somewhat cryptic notation. For purposes of clarity, reference is made to a bibliographic section set forth at the end of this BACKGROUND OF THE INVENTION where full citations of references discussed and other references of interest are identified in their entirety.

The optimum pH for microbial growth is dependent on the specific microorganisms and their respiration pathways. Aerobic microorganisms often tolerate a wider range in pH, whereas many anaerobes are sensitive to pH and operate efficiently only in a narrow pH range. Denitrification and methanogenic biodegradation rates are usually optimum between a pH of 7 and 8 SU, and may drop off rapidly below a pH of 6 SU (van den Berg, 1974; US EPA, 1975). The pH of most water supply aquifers is between 6.0 and 8.5 SU, although water having lower pH is not uncommon (Hem, 1999).

While microbial populations can endure a wide range of pH, a pH close to neutral (6 to 8 SU) is the most conducive to the growth and proliferation of healthy and diverse microbial populations necessary for anaerobic dechlorination. Low pH conditions (<5 SU) are detrimental to sulfate-reducing, methanogenic, and dechlorinating bacteria. Dehalococcoides Ethogenes are the only known organisms that can completely dechlorinate perchloroethene (PCE) and trichloroethene to the non-toxic endproduct ethene. However, Dehalococcoides E. appear to be very pH sensitive. Young and Gossett (1997) found that dechlorination of PCE was four-fold slower at pH 6 than at pH 7 SU in a series of experiments with an enrichment culture known to contain Dehalococcoides.

A variety of heavy metals can be immobilized in situ by increasing the aquifer pH. Barium (Ba), cadmium (Cd), chromium (Cr), lead (Pb), and mercury (Hg) have a reduced solubility under alkaline conditions (Dragun, 1988) so these metals can be precipitated in situ by adjusting the pH. Other contaminants including arsenic can be treated by enhancing iron (Fe) or manganese (Mn) precipitation through pH adjustment. In addition, heavy metal removal can be enhanced by adjusting the pH to enhance sorption to mineral surfaces including iron, manganese, alumina, silica oxides and their respective hydrous, anhydrous hydroxy, and oxyhydroxy forms (Bethke, U.S. Pat. No. 7,141,173, November, 2006).

Heavy metals can be further reduced using a combination of pH and redox adjustment. Deutsch et al. (2002) describe the enhanced removal of Fe and As induced by addition of an oxidizing agent and alkaline material. Miller et al. (2006) demonstrated that addition of dissolved NaOH could be used to increase the pH of acidic groundwater (pH 3 to 4 SU), reducing levels of dissolved cadmium, copper (Cu), lead, manganese, nickel (Ni), and zinc (Zn). However, use of calcium polysulfide (CPS) in combination with sodium hydroxide (NaOH) was most effective in treating severe conditions.

Chemical oxidation processes can be used to treat subsurface material and groundwater contaminated with organic and inorganic pollutants. Many of these processes have an optimum pH for destruction or immobilization of the pollutants. For example, chemical oxidation in combination with pH adjustment can be used to precipitate iron, manganese and arsenic (Hem, 1999). Persulfate in combination with high pH can be used to chemically oxidize a variety of subsurface contaminants including chlorinated ethenes, ethanes, and methanes, mono- and polynuclear aromatic hydrocarbons, oxygenates, petroleum hydrocarbons, chlorobenzenes, phenols, pesticides, herbicides, ketones and polychlorinated biphenyls (FMC Environmental Solutions, Klozur Activation Chemistries, 2006; Block et al., 2006, US Patent Application 20060054570, ITRC, 2006; Brown et al., 2006; White et al. 2006; Crimi and Taylor, 2006). However, pH levels greater than 10.5 SU are required activate persulfate enhancing oxidative degradation of many target compounds (ITRC 2006; Crimi and Taylor, 2007). Achieving these high pH levels can be difficult due to the strong buffering capacity of many subsurface materials. Block et al. (2005) describe a process for oxidizing organic compounds where the organic compound is contacted with a composition of a water soluble peroxygen and a water soluble pH modifier (e.g. sodium and potassium hydroxide), which maintains the pH of the composition at greater than about 10 SU). However, a solid alkaline material such as CaO or Ca(OH)₂ could also be used to increase the pH to greater than 10 SU.

Chemical reduction processes can also be used to treat subsurface material and groundwater contaminated with organic and inorganic pollutants. For example, Boparai et al. (2006) showed that aquifer sediment and surface soils contaminated with herbicides can be treated with dithionite when the pH is increased to 8.5 SU. However, at the ambient pH of 6.9 SU, there was no transformation of the pollutant. Similar results were reported by Lee and Batchelor (2002) who reported an increase in the TCE dechlorination rate when the pH was increased from 6.8 to 8.1. A pH of 8.1 to 8.5 SU could be achieved by injection of a suspension of Mg(OH)₂.

There are a variety of different conditions that can lead to low pH conditions which can inhibit treatment processes. In the Southeastern United States, many soils and the underlying aquifers have a naturally low pH. Under anaerobic conditions, a variety of organic materials can be fermented, releasing short-chain fatty acids (butyric, propionic and acetic acids) that can further reduce pH. Frizzell et al. (2004) found that injecting a mixture of high-fructose corn syrup and cheese whey stimulated biological activity resulting in a drop in pH to below 4.0 SU.

Currently, there are two available methods for increasing aquifer pH. The first and most common method is to circulate a solution containing a dissolved base or alkaline material through the treatment zone. Materials commonly used include aqueous solutions of NaOH, potassium hydroxide (KOH), sodium carbonate (Na₂CO₃), sodium bicarbonate (NaHCO₃), and sodium metasilicate (Na₂SiO₃). Arcadis (2002) and Lutes et al. (2006) describe methods for circulating buffer solutions containing carbonates, bicarbonates, or phosphates to control pH declines. Cline et al. (2005) describes injection of KOH solutions to increase the aquifer pH from 4.5 to as high as 6.6 SU to enhance reductive dechlorination of PCE at a dry cleaning store.

While circulating alkaline solutions through the treatment zone can be effective, there are some major disadvantages to this approach. As the alkaline solution migrates through the formation, the alkalinity present in the water reacts with the acidic mineral surfaces and is consumed. Consequently, a large amount of alkaline material must be added to increase the pH. This can be accomplished by injecting multiple pore volumes of dilute base or smaller amounts of very concentrated base. Injecting multiple pore volumes is difficult to implement and increases costs. Injecting very concentrated base will increase the pH to unacceptable levels and can expose site workers to safety hazards.

A second approach for increasing the pH of the formation is to inject a solid alkaline material. These materials can be injected by boring a hole in the subsurface followed by gravity or pressure injection of a slurry. Solid alkaline materials that can be used in this approach include magnesium oxide (MgO), magnesium hydroxide (Mg(OH)₂), magnesium carbonate (MgCO₃), calcium oxide (CaO), calcium hydroxide (Ca(OH)₂), and calcium carbonate (CaCO₃). Deutsch et al. (2002) describe the injection of a slurry of MgO and Mg(OH)₂ to increase the pH and redox potential to precipitate iron and arsenic. While this approach has the advantage over aqueous injection in that large amounts of material can be quickly injected, the beneficial increase in pH is often limited to the immediate area around the injection point. The alkaline solids can be distributed further away from the injection point by physically mixing the subsurface material using large augers or mixers. However, physical mixing is very expensive and disruptive.

### Bibliographic Citations

U.S. Patent Documents

| | | | |
|---|---|---|---|
| 3692898 | September, 1972 | Gorman et al. | 424/689 |
| 4340253 | July, 1982 | Breland | 299/5. |
| 4401569 | August, 1983 | Jhaveri et al. | 210/747. |
| 4418961 | December, 1983 | Strom | 299/5. |
| 5008019 | April, 1991 | Trost | 210/747. |
| 5265674 | November, 1993 | Frederickson et al. | 166/246. |
| 5277815 | January, 1994 | Beeman | 210/605. |
| 5324433 | June, 1994 | Grant | 210/634. |
| 5487879 | January, 1996 | Witkowski et al. | 423/155 |
| 5514357 | May, 1996 | Richmond et al. | 423/265 |
| 5554290 | September, 1996 | Suthersan | 210/610. |
| 5264018 | December, 1997 | Koenigsberg et al. | 71/63 |
| 5725470 | March, 1998 | Lazarowitz et al. | 210/747. |
| 5762901 | June, 1998 | Richmond et al. | 423/635 |
| 5840571 | November, 1998 | Beeman et al. | 435/262. |
| 5846179 | December, 1998 | Price | 588/261. |
| 5993660 | November, 1999 | Shook et al. | 210/747. |
| 5989517 | November, 1999 | Richmond | 423/636. |
| 6059973 | May, 2000 | Hudson et al. | 210/610. |
| 6110372 | August, 2000 | Perriello | 210/747. |
| 6143195 | November, 2000 | Price | 252/186.1. |
| 6267888 | July, 2001 | Satyanarayana | 210/610. |
| 6398960 | June, 2002 | Borden et al. | 210/610 |
| 20040245185 | December, 2004 | Chowdhury | 210/749. |
| 7160471 | January, 2007 | Looney et al. | 210/747 |
| 20060054570 | March, 2006 | Block et al. | 210/759 |
| 7141173 | November, 2006 | Bethke | 210/660. |

International patents

| | | | |
|---|---|---|---|
| WO 1993/ | 2003 | Bircher et al. | PCT/A1 |
| 9301136 | | | 19930121 |
| WO 2005/ | February, 2004 | Block | PCT/US2005/ |
| 081996 | | | 005852 |

### OTHER PUBLICATIONS

AFCEE, 2004. Principles and Practices of Enhanced Anaerobic Bioremediation of Chlorinated Solvents, Air Force Center for Environmental Excellence/Naval Facilities Engineering Service Center/Environmental Security Technology Certification Program, Brooks City-Base, TX, August 2004.
Arcadis, 2002. Technical Protocol for Using Carbohydrates to Enhance Reductive Dechlorination of Chlorinated Aliphatic Hydrocarbons. Report prepared for ESTCP (Contract #F41624-99-C-8032).
Block, P. A., R. A. Brown and D. Robinson, 2004. “Novel Activation Technologies for Sodium Persulfate In Situ Oxidation.” In: Gavaskar, A. R. and A. S. C. Chen (eds.), Remediation of Chlorinated and Recalcitrant Compounds—2004. Proceedings of the Fourth International Conference on Remediation of Chlorinated and Recalcitrant Compounds (Monterey, Calif.; May 2004). ISBN 1-57477-145-0, Battelle Press, Columbus. Ohio.
Boparai H. K. P. J. Shea. S. D. Comfort and D. D. Snow. 2006. “Dechlorinating Chloroacetanilide Herbicides by Dithionite-Treated Aquifer Sediment and Surface Soil” Environmental Science and Technology, 40, 3043-3049.
Borden, R. C., “Natural Bioremediation of Hydrocarbon-Contaminated Groundwater.” _In: Norris, Hinchee, Brown, McCarty, Semprini, Wilson, Kampbell, Reinhard, Bouwer, Borden, Vogel, Thomas and Ward (eds.), Handbook of Bioremediation. ISBN 1-56670-074-4, 1994, CRC Press, Boca Raton, Fla.
Brown, R. A., P. Block, R. J. Watts and A. L. Teel, 2006. Presentation abstract: “Contaminant-Specific Persulfate Activation”. The Fifth International Conference on Remediation of Chlorinated and Recalcitrant Compounds (Monterey, Calif., May 22-25). Battelle 2006.
Cline, D. M., P. J. W. Jackson and M. Collins III. 2005. “KOH Injections in Low-pH Aquifers to Enhance Anaerobic Degradation.” In: Allerman, B. C. and M. E. Kelly (Conf. Chairs). Proceedings of the Eight International In Situ and On-Site Bioremediation Symposium (Baltimore, Md., Jun. 6-9, 2005). ISBN 1-57477-152-3, Battelle Press, Columbus, Ohio.
Crimi, M. L. and J. Taylor, 2007. Experimental evaluation of catalyzed hydrogen peroxide and sodium persulfate for destruction of BTEX contaminants. Soil and Sediment Contamination, 16: 29-45.
Deutsch, W. J., M. Dooley, S. Koenigsburg, B. Butler and G. Dobbs, 2002. “In Situ Redox Manipulation for Arsenic Remediation.” In: Proceedings of the Third International Conference on Remediation of Chlorinated and Recalcitrant Compounds (Monterey, Calif. May 20-23, 2002.) ISBN 1-57477-132-9, Battelle Press, Columbus, Ohio.
Dragun, J. 1988. The Soil Chemistry of Hazardous Materials. Hazardous Materials Control Research Institute, Silver Springs, Md.
Duffy, B. E., G. Oudijk and J. H. Guy, 1999. “Enhanced Aerobic Bioremediation of Petroluem UST Releases in Puerto Rico.” In: Koenigsberg, S S. and R. D. Norris (eds.). Accelerated Bioremediation Using Slow Release Compounds, Selected Battelle Conference Papers: 1993-1999. Regenesis Bioremediation Products, 1999, pp 181-186.
FMC Environmental Solutions, 2005. Klozur™ Activated Persulfate. http://envsolutions.fmc.com/Klozur8482/tabid/355/default.aspx.
Freeman, H. M., (Ed), 1988. Standard Handbook of Hazardous Waste Treatment and Disposal. ISBN 0-07-022042-5. McGraw-Hill Book Company, NY, N.Y., Page 9.21.
Frizzell, A., C. C. Lutes, H. Voscott and M. Hansen. 2004. “Enhanced Reductive Dechlorination of a PVE Plume using Corn Syrup and Cheese Whey.” In: Principles and Practices of Enhanced Anaerobic Bioremediation of Chlorinated Solvents, Appendix E. AFCEE/NFESC/ESTCP, Brooks City-Base, TX. August 2004.
Hem, J. D., 1985. Study and interpretation of the chemical characteristics of natural waters, USGS Water Supply Paper 2254, 1985.
Interstate Technology & Regulatory Council, 2005. Technical and Regulatory Guidance for In Situ Chemical Oxidation of Contaminated Soil and Groundwater, 2^{nd} Ed.
Koenigsberg, S. S. and R. D. Norris (eds.), 1999. Accelerated Bioremediation Using Slow Release Compounds, Selected Battelle Conference Papers: 1993-1999. Regenesis Bioremediation Products, 1999.
Lee, W. and B. Batchelor, 2002. “Abiotic Reductive Dechlorination of Chlorinated Ethylenes by Iron-Bearing Soil Minerals” Environmental Science and Technology, 36, 5348-5354.
Lutes, C. C., A. Frizzell, and S. S. Suthersan, 2006. “Enhanced Reductive Dechlorination of CAHs using Soluble Carbohydrates—A Summary of Detailed Data from 50 Sites.” In: Principles and Practices of Enhanced Anaerobic Bioremediation of Chlorinated Solvents, Appendix E. AFCEE/NFESC/ESTCP, Brooks City-Base, TX. August 2004.
Miller, G., M. Hayter and P. Storch. 2006. Abstract: In Situ Treatment of Acidic, Metal-Impacted Groundwater Using Calcium Polysulfide and Sodium Hydroxide. The Fifth International Conference on Remediation of Chlorinated and Recalcitrant Compounds (Monterey, Calif. May 22-25). Battelle 2006.
Root, D. K., E. M. Lay and T. Ladaa. 2006. Poster abstract: “Sodium Persulfate ISCO Applications Using New Methods of Reagent Activation.” The Fifth International Conference on Remediation of Chlorinated and Recalcitrant Compounds (Monterey, Calif. May 22-25). Battelle, Columbus, Ohio.
Solutions-IES, 2004. Edible Oil Emulsion for Treatment of Chlorinated Solvent Contaminated Groundwater; Technology Demonstration Plan. ESTCP, February 2004.
US EPA, 1975. “Chapter 5—Biological Denitrification” In: Parker et al. (eds.), Process Design Manual for Nitrogen Control, US Environmental Protection Agency.
Vainberg, S., R. J. Steffan, R. Rogers, T. Ladaa, D. Pohlman and D. Leigh, 2006. Presentation abstract: “Production and application of large-scale cultures for bioaugmentation.” The Fifth International Conference on Remediation of Chlorinated and Recalcitrant Compounds (Monterey, Calif. May 22-25). Battelle, Columbus, Ohio.
van den Berg, L., 1974. Assessment of methanogenic activity in anaerobic digestion: Apparatus and Method, Biotech. Bioeng. 16: 1459-1469.
White, B., R. Wong, S. Adams, P. Block and M. Pound, 2006. Poster abstract: Bench and Pilot Scale Treatment of TCE by Activated Persulfate. The Fifth International Conference on Remediation of Chlorinated and Recalcitrant Compounds (Monterey, Calif. May 22-25). Battelle, Columbus, Ohio.
Wiedemeier, T. H., J. T. Wilson, D. H. Kampbell, R. N. Miller, and J. E. Hansen, 1995. Technical Protocol for Implementing Intrinsic Remediation with Long-Term Monitoring for Natural Attenuation of Fuel Contamination Dissolved in Groundwater. AFCEE, Brooks AFB, San Antonio, Tex., 1995.
Young, R. G. and J. M. Gossett, 1997. “Effect of environmental parameters and concentrations on dechlorination of chloroethenes”. Presented at the Fourth International In Situ and On-Site Bioremediation Symposium (New Orleans, La.). Batelle, Columbus, Ohio.

### BRIEF SUMMARY OF THE INVENTION

In accordance with the invention there is provided a safe, low-cost, effective method to increase the pH of subsurface treatment zones through injection of a suspension of solid alkaline material where the average particle size of the suspension is less than the mean pore size or fracture aperture of the subsurface material. The method of the invention enhances a wide variety of in situ treatment processes including aerobic and anaerobic bioremediation, chemical oxidation and reduction, and stabilization/immobilization by adjusting the pH necessary to enhance remediation.

In the subsurface, the suspension of alkaline solids can increase the pH to a more desirable range, increasing the effectiveness of a range of treatment processes. Using a suspension of alkaline solids with an average particle size less than the mean pore size or mean fracture aperture of the subsurface material allows for improved distribution of the alkaline solids away from the injection points. In addition, the method of the invention may be implemented in a variety of configurations, including permeable reactive barrier (PRB) and broad area coverage.

Other advantages of the invention will be more fully apparent from the following detailed disclosure made with reference to the Figures.

### BRIEF DESCRIPTION OF THE DRAWINGS

FIG. 1 is a chart showing the results of a laboratory study where varying amounts of Mg(OH)₂ were added to aquifer sediment and the pH was measured after equilibrating for 24 hours. Results are presented in base equivalents per kilogram of sediment.

FIG. 2 is chart a showing the variation in pH in injection wells, pilot test monitor wells, and upgradient-untreated monitor wells. The pH increased to an optimal range for reductive dechlorination following injection of the Mg(OH)₂/soybean oil suspension between 860 and 880 days.

### DETAILED DISCUSSION OF THE INVENTION

The present invention provides a method for adjusting the pH, in particular, increasing the pH of subsurface treatment zones through injection and distribution of a suspension of alkaline solid material where the average particle size of the suspension is less than the mean pore size or fracture aperture of the subsurface material. By increasing the pH to within a selected range, the efficacy of several different treatment processes can be enhanced including anaerobic bioremediation, aerobic bioremediation, chemical oxidation, chemical reduction, and immobilization. These different treatment processes can then be used to enhance the destruction and/or immobilization of a variety of contaminants including organic compounds, inorganic compounds, metals and radionuclides. The preferred method of the invention involves the preparation and distribution of the suspension throughout the target treatment zone in unconsolidated material or fractured rock above or below the water table.

The invention involves a method for increasing the pH by the introduction of a solid alkaline material formulated into a suspension where the particle size, surface charge, degree of flocculation and settling rate are controlled to enhance transport and distribution throughout the treatment zone. Ideal characteristics of the suspension include: 1) mean particle size less than the mean pore size or fracture aperture of the subsurface material; 2) negative surface charge to reduce capture by negatively charged surfaces; 3) non-flocculating suspension to prevent formation of large flocs which could become trapped in the pores, and 4) slow settling rate to reduce separation during injection and enhance transport in the subsurface. Ideal characteristics of the alkaline solid include: 1) low cost; 2) large acid neutralizing capacity per mass material; 3) low toxicity and absence of harmful impurities; 4) slow to moderate dissolution rate to allow transport significant distances before dissolution; 5) equilibrium pH in appropriate range to achieve treatment objective.

The typical process of applying the invention involves the following steps: 1) determining the treatment zone dimensions; 2) selecting a pH required to achieve treatment objectives; 3) determining the amount of alkaline material required to increase the pH to the desired range; 4) preparing the alkaline suspension; and 5) injecting the alkaline suspension into the subsurface.

The size and dimensions of the treatment zone are determined based on the treatment objectives and the results of soil and/or groundwater sampling. For example, if the objective is to treat a source area, then samples of subsurface material (soil, aquifer sediment or rock) are collected at several different locations and depths and analyzed to determine if the pollutant concentrations are above allowable levels. Results of these analyses are plotted on maps or cross-sections and used to identify zones requiring treatment. If the objective is to treat a groundwater plume by forming a permeable reactive barrier, then groundwater samples are collected from monitoring wells or direct-push points to define the zone where contaminant concentrations exceed allowable levels.

The pH required to reach treatment objectives is determined based on the treatment process to be implemented. The optimum pH for aerobic and anaerobic treatment processes is typically in the range of about 6 to about 8 SU. The optimum pH for other treatment processes is known from prior art on each treatment process. The optimum pH can also be determined from a simple laboratory test where: a) the pH of the subsurface material is adjusted to within a specified range using common acids or bases; b) the treatment process is applied; and c) destruction or immobilization of the pollutant is monitored using standard chemical assays. The test is then repeated for a different pH until the optimum pH for treatment is determined.

The amount of alkaline material required to increase the pH to the desired range is determined by collecting samples of groundwater and solid subsurface material from several locations within the treatment zone. A slurry composed of equal parts groundwater and solid subsurface material is prepared and amended with varying amounts of NaOH or other alkaline material. The slurry is then allowed to equilibrate for 24 hours and then the pH is measured. A graph is then prepared showing the base equivalents required to increase the pH to different levels. Results are typically plotted as base equivalents per mass of solid subsurface material versus pH. The amount of alkaline material required is determined as:

Alkaline Material required=treatment volume×bulk density×base equivalents required×pounds per base equivalent

The treatment zone volume is determined as described above. The bulk density of the subsurface material is determined by standard test procedures and typically varies between 100 and 125 pounds per cubic foot. The base equivalents required to reach the target pH is determined from the laboratory test described above. Table 1 shows the equilibrium pH and pounds of pure alkaline material per base equivalent for common solid alkaline materials that may be used in this invention.

TABLE 1
Properties of different alkalis used in pH adjustment.

| Alkaline | | Pounds per base |
|---|---|---|
| material | Equilbrium pH | equivalent |
| MgO | 10.3 | 0.044 |
| Mg(OH)₂ | 9.5–10.5 | 0.064 |
| MgCO₃ | 8.0–8.5 | 0.093 |
| CaO | 12.5 | 0.062 |
| Ca(OH)₂ | 11.4 | 0.082 |
| CaCO₃ | 8.0–8.5 | 0.110 |

The alkaline material used in the process will be selected based on: a) the equilibrium pH; b) the pounds of alkaline material required per base equivalent; and c) the cost per pound of the alkaline material. The optimum alkaline material will have an equilibrium pH slightly higher than the required pH of the treatment process. Mixtures of alkaline materials can also be used.

The alkaline suspension is prepared from fine particulate alkaline material. Solid alkaline materials that are available include MgO, Mg(OH)₂, MgCO₃, CaO, Ca(OH)₂, CaCO₃. These materials may be purchased in a fine particulate form or specially ground to provide a mean particle size less than the pore size or fracture aperture of the subsurface material. Selection of a specific alkaline material will depend on the cost of the material and the target pH. For example, suspensions of MgO and Mg(OH)₂ are useful in bioremediation applications because these materials have an equilibrium pH that is slightly higher than the target pH for bioremediation and they provide a large number of base equivalents per pound of alkali. CaO and Ca(OH)₂ are more useful as buffering agents in chemical treatment processes since these materials generate a higher pH. CaO and Ca(OH)₂ may be less useful for bioremediation applications since the high pH generated by these materials may adversely impact microorganisms. Carbonates (MgCO₃, CaCO₃) can be useful for in situ precipitation processes. However, their use can result in excessive gas production with undesirable impacts on formation permeability. In some cases, the suspension may be amended with liquid or dissolved bases to provide additional alkalinity or provide a broader pH range. Liquid or dissolved alkalis that may be added include NaOH, KOH, Na₂CO₃, NaHCO₃, ammonium hydroxide (NH₄OH), ammonium carbonate ((NH₄)₂CO₃), sodium tripolyphosphate (Na₅P₃O₁₀), dibasic sodium phosphate (Na₂HPO₄) and trisodium phosphate (Na₃PO₄). Materials containing ammonia or phosphate are also beneficial in bioremediation applications as a source of inorganic nutrients.

In most cases, a concentrated alkaline suspension is prepared at a manufacturing facility in a conventional manner well known to those of ordinary skill. The amount of water in the suspension is minimized to reduce shipping costs. However, sufficient water is provided to hydrate the suspension and maintain a sufficiently low viscosity to allow pumping and mixing using commonly available pumps and mixers. The suspension may also be amended with chemical agents (anionic, cationic, nonionic and amphoteric/zwitterionic surfactants and coagulants) to control the surface charge and reduce flocculation of the particulate material. Chemical agents may also be added to increase the viscosity of the dispersed phase, thereby reducing agglomeration and/or settling of the particulate material. Agents that can be used to increase the viscosity include agar, lignin, alginates, arrowroot, carageenan, collagen, cornstarch, fecula, gelatin, glycerol, katakuri, pectin, tapioca, Arabic gum, guar gum, locust bean gum, xanthan gum, starch derivatives and cellulose derivatives.

Other materials may be added to the suspension to enhance in situ treatment processes including solid or liquid electron donors, electron acceptors, microbial growth factors, chemical oxidants, chemical reductants, and stabilizing agents to enhance in situ remediation processes. Organic substrates that can be provided as electron donors include short, medium and long-chain fatty acids, sugars, carbohydrates, proteins, solid fats, liquid oils, emulsified fats and oils, and other biodegradable organic substrates. Electron acceptors include peroxides, nitrates, nitrites, and/or sulfates. Microbial growth factors include inorganic nutrients, vitamins, trace minerals, and amino acids. Chemical oxidants include hydrogen and metal peroxides, peroxygens, persulfate, permanganate, and other oxidizing compounds. Chemical reductants include reactive metals, monosulfides, polysulfides, dithionites and other reducing compounds. Chemical stabilizing agents including phosphates, chemical oxidants and chemical reductants.

Typically, a coarse suspension is prepared by mixing the materials together in a tank or kettle. Heat may be applied to aid in the initial mixing process. The coarse suspension is then passed through a high energy mixing device to reduce the size of any liquid or solid particles. Available mixing devices including high shear mixers, colloid mills and high pressure homogenizers. Multiple passes through the mixing device may be required to reduce the particle size. Once prepared, the concentrated suspension is placed in drums, totes or other suitable containers and transported to the field site.

In the field, the concentrated suspension is diluted with water prior to injection. The amount of concentrated suspension is selected to provide sufficient alkalinity to increase the pH of the formation to the desired range to enhance in situ treatment processes. The amount of water is selected to distribute the suspension throughout the target treatment zone. In the preferred embodiment, a concentrated alkaline suspension is prepared ahead of time in a manufacturing facility, and then diluted with water on site. However, if desired, a dilute or concentrated suspension could be prepared on site.

Once the alkaline suspension has been prepared, it is injected into the subsurface. The diluted suspension can be injected under low pressure to readily disperse the suspension away from the injection points. By diluting the suspension first with water, broader coverage and wider impact area can be achieved, using fewer injection points. Alkaline material suspensions can be injected through the end of a direct push rod, through temporary 1-inch direct-push wells, or through temporary or permanent 2-inch or 4-inch conventionally-drilled wells. The suspension can also be injected using pneumatic or hydraulic fracturing.

A number of manufacturers offer direct-push equipment that can be utilized for installation of temporary 1-inch direct-push wells or direct inject of the alkaline material suspension through probe rods. Geoprobe® manufactures and sells tooling for injection of remediation products. This tooling can also be utilized to inject an alkaline material suspension. The Geoprobe® Pressure-Activated Injection Probe can be utilized with either 1.5-inch or 1.25-inch probe rods for “top-down” or “bottom-up” injection. Geoprobe® also sells injection Pull Caps that provide a means to make a sealed connection to the probe rods for injection while retracting the probe rod. An alternative method is to inject the alkaline material suspension “bottom-up” through the Geoprobe® rods using an expendable drive point tip.

The selection of temporary versus permanent injection points depends on site-specific conditions including: depth to water, drilling costs, flow rate per injection point and volume of fluid that must be injected. Injection designs should be optimized to provide the maximum injection flow rate while trying to minimize the drilling cost.

Recirculation (groundwater recovery and re-injection) can be used to eliminate or reduce the need for an accessible supply of (potable) water for mixing. Practitioners should note that the reuse of groundwater is subject to regulation by many States, and specific requirements for its treatment and/or handling may be required. Nevertheless, the most common approach is to pump groundwater from one or more wells and inject the groundwater along with the alkaline material suspension into one or more injection wells. The injection process is continued until the design volume has been emplaced or field pH measurements support that the alkaline material suspension has been distributed throughout the treatment zone.

In lower permeability formations, hydraulic and pneumatic fracturing can be used to enhance distribution of the alkaline suspension away from the injection point. Hydraulic fractures are formed when a fluid is pumped down a well at high pressures for short periods of time (hours) to create enough downhole pressure to crack or fracture the formation. The suspension or water with some specialty high viscosity fluid additives can be used as the high pressure fluid. To keep the fractures from closing when the pumping pressure is released, a propping agent such as sand or other coarse particulate material can be pumped into the formation, thereby creating a plane of high-permeability sand through which fluids can flow. The propagant remains in place once the hydraulic pressure is removed. This allows the fracture to remain open and enhances flow in the subsurface.

In pneumatic fracturing, a gas is pumped down a well at high pressures for short periods of time (hours) to create enough downhole pressure to crack or fracture the formation. The gas is injected into the subsurface at pressures that exceed the natural in situ pressures present in the soil/rock interface and at flow volumes exceeding the natural permeability of the subsurface.

The invention can be implemented in a variety of configurations in the subsurface, including source area treatments, plume treatments, and permeable reactive barrier (PRB) configurations. Source area and plume treatments involve distributing the alkaline suspension and related amendments in a portion of the source area or plume to degrade contaminants and/or reduce their mobility. A PRB can be formed by distributing alkaline solids in a line generally perpendicular to groundwater flow. As groundwater passes through the PRB, the pH increases enhancing destruction and/or immobilization of the contaminants.

After injection of the suspension and other additives has been completed, the “invention” works without further operation and maintenance. The alkaline solids slowly dissolve increasing the pH to the preferred range and enhancing contaminant degradation and/or immobilization. Preferred embodiments of this invention for enhancing a variety of subsurface treatment processes are described below.

To increase the pH of the formation to between about 8 and about 9.5 SU, prepare a concentrated suspension containing fine particulate Mg(OH)₂ with a mean particle size less than 5 microns, preferably less than 3 microns containing between about 40 and about 60 percent Mg(OH)₂, about 0.2 to about 2.0 percent xanthan gum and about 0.1 to about 1.0 percent sodium carboxymethylcellulose with the balance composed of water (all percentages in weight per total weight). Pass the suspension 1 to 10 times, preferably 3 times through an APV Gaulin Homogenizer at a pressure of 1000 to 5000 psi, preferably 2500 psi, to physically deflocculate the suspension. Place the resulting suspension into drums, totes or other containers and transport to the field site for use. At the field site, dilute 1 part by volume concentrated suspension with about 4 to about 40 parts water, and inject the diluted suspension into the subsurface. The ratio of concentrated suspension to water in the final diluted suspension will be determined based on the calculations described above for determining the amount of base equivalents required to increase the pH. To increase the pH of the formation to between about 9.5 and about 11 SU, prepare the suspension using Ca(OH)₂ in place of Mg(OH)₂. Once the formation has been treated with sufficient suspension to increase the pH to the required level, apply subsequent remediation technologies to treat the contaminants thorough aerobic bioremediation, anaerobic bioremediation, chemical oxidation, chemical reduction, immobilization or other appropriate methods as required.

To stimulate anaerobic biodegradation by adjusting the pH and amending with organic substrates, prepare a concentrated suspension containing fine particulate Mg(OH)₂ with a mean particle size less than about 5 microns, preferably less than about 3 microns containing between about 40 and about 60 percent Mg(OH)₂, about 0.2 to about 2.0 percent xanthan gum and 0.1 to 1.0 percent sodium carboxymethylcellulose with the balance composed of water (all percentages in weight per total weight). Blend the concentrated suspension with a prepared emulsified oil concentrate as containing approximately 60% soybean oil, about 4 percent lactate or lactic acid, 10 percent emulsifiers, about 2 percent amino acid extracts with the balance water (all percentages in weight per total weight). Methods for preparing soybean oil emulsions for bioremediation are known to those skilled in the art of making emulsions and are described by Borden and Lee (U.S. Pat. No. 6,398,960). Blend about 60% by volume soybean oil emulsion with about 40% by volume Mg(OH)₂ suspension. Pass the emulsion-suspension mixture through a colloid mill or high pressure homogenizer 1 to 10 times, preferably 3 times. Place the resulting suspension into drums, totes or other containers and transport to the field site for use. At the field site, dilute 1 part by volume concentrated suspension with about 4 to about 40 parts water, and inject the diluted suspension into the subsurface. The total amount of Mg(OH)₂ to inject is determined by the amount of base equivalents required to increase the pH to the desired range. If additional organic substrate is required, then the concentrated emulsion-suspension can be diluted with additional emulsion concentrate in the field or a second injection can be performed to provide additional substrate.

The features of the present invention will be more clearly understood by reference to the following examples, which are not to be construed as limiting the invention.

### EXAMPLES

### Example 1

### Field Demonstration of Buffering on Aquifer pH

A pilot study was conducted to evaluate the use of emulsified oil substrate (EOS®) for the bioremediation of TCE in a prototypical source area. The depth to ground water at the site was approximately 6 feet below ground surface (ft bgs). The subsurface material at the site consisted of 5 to 8 ft of silty sandy clay underlain by 8 to 10 ft of silty sand, with dense clay acting as a lower confining layer at approximately 16 ft bgs. The hydraulic gradient of the area was low (˜0.001 ft/ft) and groundwater velocity was also low (˜5 ft/yr). The hydraulic conductivity varied from 1 to 3 ft/d. A field pilot test had previously been conducted at this site to evaluate the use of emulsified oil alone to stimulate anaerobic biodegradation of trichloroethylene (TCE). However, this previous pilot test was not successful due to the low pH of the treatment zone. Samples of subsurface material collected 15 months after the initial emulsified oil injection found the pH to vary between 4.2 and 5.2 SU which is less than optimal for reductive dechlorination.

The invention described in this patent application was then employed at the site to alleviate the low pH problem and provide additional organic substrate to stimulate TCE biodegradation. Different alkalis were considered to increase the pH of the aquifer, including Ca(OH)₂, Mg(OH)₂, NaOH, NaHCO₃ and Na₂CO₃. The preferred alkaline material would provide a large amount of alkalinity per pound but not result in an excessively high pH near the point of injection. Ca(OH)₂, NaOH and Na₂CO₃ have maximum pH values of 12 or greater, which could result in toxicity due to a very high pH near the injection point. In contrast, NaHCO₃ would buffer the pH near optimum (7 to 8), but NaHCO₃ provides the least alkalinity per pound. Also, addition of NaHCO₃ to the acidic aquifer would result in degassing large amounts of CO₂, which could cause blockage of the aquifer.

Based on the characteristics of each agent, Mg(OH)₂ was chosen as a pH buffer. The pH of pure Mg(OH)₂ is ˜10 SU, so the pH within most of the aquifer can be expected to vary between 6 and 8 which is optimal for biodegradation. Also, Mg(OH)₂ addition would require less material to inject and would not result in CO₂ degassing.

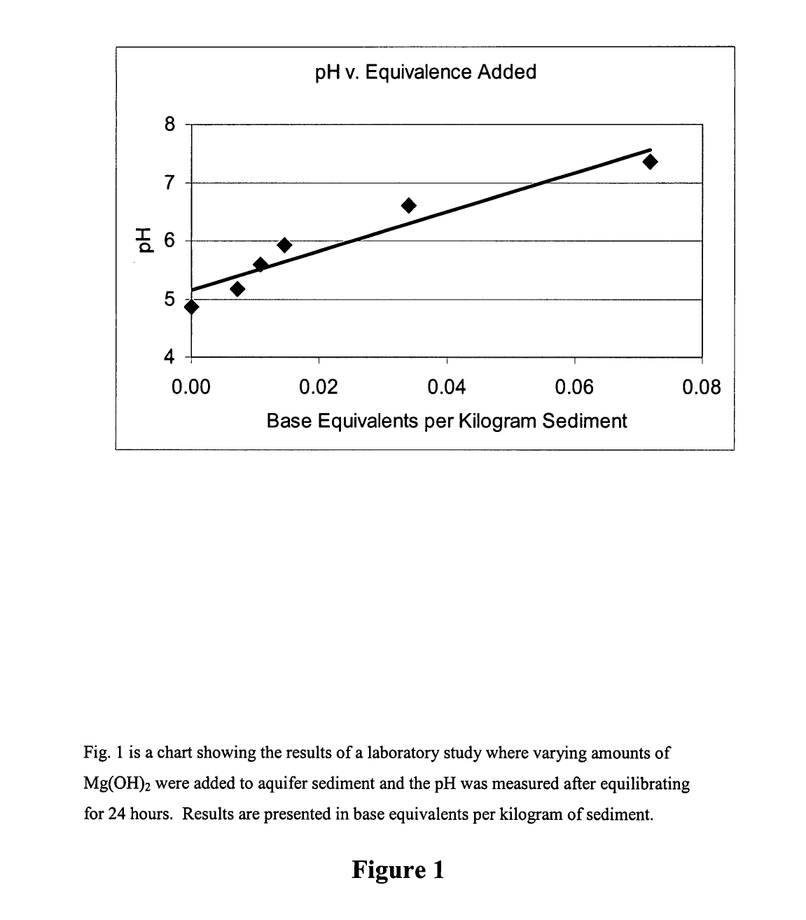

Aquifer sediment from the pilot test site was amended with varying amounts of Mg(OH)₂ and equilibrated for 24 hours to determine the amount of base equivalents needed to increase the pH to different values. FIG. 1 shows the resulting pH achieved by increasing amounts of Mg(OH)₂. Results are presented in base equivalents per Kg of sediment. Based on these results, the amount of Mg(OH)₂ required to increase the pH of the pilot test area was calculated.

Assuming uniform mixing throughout the 20 ft×20 ft×10 ft treatment volume with a sediment bulk density of 100 lb/ft³, approximately 16,000 base equivalents would be required to raise the pH of the pilot test area to approximately 7 to 8 SU. This is equivalent to about 1,000 lb of pure Mg(OH)₂. Approximately two years had passed since the original emulsified oil injection at the site and it was determined that additional emulsified oil should be injected to increase the amount of organic carbon available for reductive dechlorination.

Two formulations were prepared:
1. Soybean oil, water, lactic acid, sodium lactate, yeast extract and food grade surfactants were blended together to form a coarse emulsion. This emulsion was then passed through a colloid mill to generate a fine emulsion with small uniform droplets. This emulsion was then blended with a Mg(OH)₂ slurry product (62% slurry by weight) with a median particle diameter of 3 microns at a ratio of 60% by volume soybean oil emulsion: 40% Mg(OH)₂ slurry. The mixture was then repeatedly passed through a colloid mill while monitoring the change in particle size and suspension properties. After five passes through the colloid mill, a stable suspension was obtained and the mixed emulsion—suspension was drummed for shipment. This material had a final pH of 9.3 and density of 1,130 kg/m³.
2. Powdered Mg(OH)₂ with a median particle diameter of 1 micron was hydrated with water (i.e., 1 part powder to 2 parts water) for several days. The hydrated powder was then mixed with the soybean oil emulsion prepared as described above. The mixture was then repeatedly passed through a colloid mill while monitoring the change in particle size and suspension properties. After five passes through the colloid mill, a stable suspension was obtained and the mixed emulsion—suspension was drummed for shipment. This material had a final pH of 9.3 and density of 1,099 kg/m³.

The Mg(OH)₂/soybean oil suspension was injected through nineteen direct push injection points (IP). The injection points were located approximately midway between the injection points used in the previous unsuccessful pilot study. The injection was performed via the Geoprobe® Pressure-Activated Injection Probe outfitted with 1.25-inch probe rods. The concentrated suspension was first diluted in a large tank with tap water using approximately 1 part concentrate to 4 parts water. The diluted suspension was then injected under pressure from “bottom-up” through the Geoprobe® rods using an expendable drive point tip.

Injections were performed by boring down to 16 ft bgs and injecting the mixture directly through the Geoprobe rod. Initial plans were to inject a total of 22 gallons of the mixture followed by 20 to 80 gallons of chase water with the fluid distributed evenly over the entire saturated zone (6 to 16 ft bgs). However, groundwater was observed being pushed out of monitor wells and the ground due to displacement by the mixture. For this reason, the amount that could be injected into each point varied and the injection occurred in two separate phases. During the second phase, many of the injections occurred only at the depths where the hydraulic conductivity was greatest, which for most injection points was approximately 13 to 16 ft bgs. Tables 2 and 3 detail the amount of mixture and chase water injected into each point.

TABLE 2
Amount of Mg(OH)₂/soybean oil suspension and chase
water injected in ilot test area in Phase 1

| | Mg(OH)₂/Soybean | Mg(OH)₂/Soybean | Water | Total |
|---|---|---|---|---|
| Injection | Oil Suspension | Oil Suspension | Injected | Injected |
| Point | Injected (gal.) | Injected (lbs.) | (gal.) | (gal.) |
| IP 1 | 15 | 140 | 55 | 70 |
| IP 2 | 15 | 140 | 30 | 45 |
| IP 3 | 14 | 131 | 52 | 66 |
| IP 4 | 22 | 206 | 78 | 100 |
| IP 5 | 22 | 206 | 78 | 100 |
| IP 6 | 22 | 206 | 78 | 100 |
| IP 7 | 12 | 112 | 23 | 35 |
| IP 9 | 8 | 75 | 27 | 35 |
| IP 10 | 22 | 206 | 78 | 100 |
| IP 11 | 5 | 47 | 10 | 15 |

TABLE 3
Amount of Mg(OH)₂/soybean oil suspension and chase water injected into
pilot test area in Phase 2

| | Mg(OH)₂/Soybean | Mg(OH)₂/Soybean | Water | Total |
|---|---|---|---|---|
| Injection | Oil Suspension | Oil Suspension | Injected | Injected |
| Point | Injected (gal.) | Injected (lbs.) | (gal.) | (gal.) |
| IP 8 | 5 | 47 | 10 | 15 |
| IP 12 | 33 | 309 | 67 | 100 |
| IP 13 | 20 | 187 | 39 | 59 |
| IP 14 | 5 | 47 | 10 | 15 |
| IP 15 | Not Performed | | N/A | N/A |
| IP 16 | 5 | 47 | 11 | 16 |
| IP 17 | 15 | 140 | 30 | 45 |
| IP 18 | 33 | 309 | 67 | 100 |
| IP 19 | 20 | 187 | 40 | 60 |
| IP 20 | 33 | 309 | 67 | 100 |

Approximately 326 gallons (3050 lbs)of Mg(OH)₂/soybean oil suspension were injected into the aquifer containing about 1000 lbs of pure Mg(OH)₂ along with 850 gallons of water. Soil borings were collected immediately prior to and three months after the initial injection to determine how well the Mg(OH)₂/soybean oil suspension buffered the aquifer.

Table 4 shows the average pH in samples collected at each depth before and after injection. Prior to injection, the pH was less than 5.5 in 80% of the treatment zone. This low pH very likely inhibited reductive dechlorination of TCE. After injection, the pH had increased to between 6.4 and 8.0 in 80% of the treatment interval, the optimum range for reductive dechlorination. In the upper 20% of the treatment interval, the pH had increased by 0.5 to 0.6 pH units. However, it was still below optimum. Injection in this zone had less beneficial effects because the low permeability of the soil at this depth prevented injection of sufficient material.

TABLE 4
Effect of Mg(OH)₂/soybean oil suspension injection
on treatment zone pH.

| | Pre- | Post- |
|---|---|---|
| | Suspension | Suspension |
| | Injection | Injection |
| Depth | Avg. ± Std. | Avg. ± Std. |
| (ft bgs) | Dev. | Dev |
| 6′–7′ | 4.9 ± 0.2 | 5.6 ± 0.5 |
| 7′–8′ | 4.9 ± 0.1 | 5.5 ± 0.6 |
| 8′–9′ | 5.0 ± 0.2 | 6.4 ± 1.0 |
| 9′–10′ | 4.5 | 7.2 ± 1.0 |
| 10′–11′ | 5.1 ± 0.3 | 7.0 ± 0.7 |
| 11′–12′ | 4.8 ± 0.0 | 7.0 ± 0.6 |
| 12′–13′ | 4.9 ± 0.3 | 7.6 ± 0.9 |
| 13′–14′ | 5.3 ± 0.6 | 8.0 ± 0.9 |
| 14′–15′ | 5.8 ± 0.6 | 7.8 ± 1.1 |
| 15′–16′ | 6.0 ± 0.2 | 7.9 ± 1.3 |

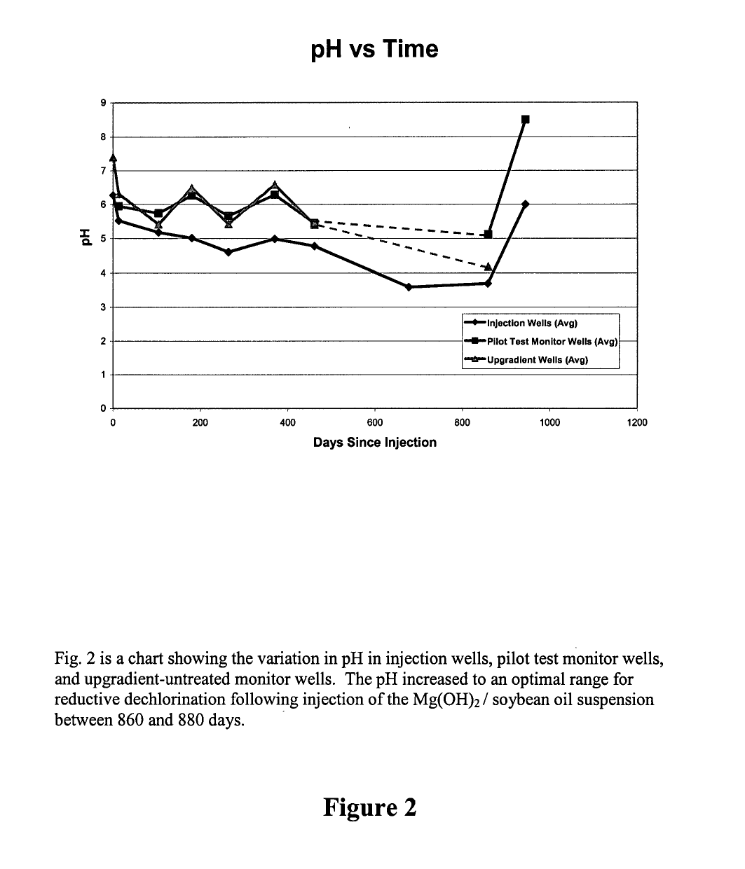

The average pH in monitor wells and injection wells within the pilot test area and in three upgradient, untreated wells is shown in FIG. 2. Over the first 400 days of the test, the pH in the monitor wells was approximately 6 while the pH in the injection wells was 5 or less. However, by about 700 days, the pH in the monitor wells had dropped to near 5 and the average pH in the injection wells was less than 4. Between 860 and 880 days, the Mg(OH)₂/soybean oil suspension was injected resulting in a sharp increase in pH to 6 in the injection wells and over 8 in the monitor wells generating good conditions for reductive dechlorination within the pilot test area.

Field monitor data showed that as pH increased, and as a result of the increase, desired biodegradation reaction occurred at effective levels.

### Example 2

### pH Adjustment to Improve In Situ Aerobic and Anaerobic Bioremediation at a Hazardous Waste Site

A large hazardous waste site was contaminated with a complex mixture of organic contaminants including aromatic hydrocarbons (benzene, toluene, ethylbenzene, xylenes), chlorobenzene, dichlorobenzene isomers, acetone, methyl ethyl ketone, 4-methyl-2-pentanone, 1,1,1-trichloroethane, cis-1,2-dichloroethene, chloroform, 1,2-dichloroethane, 1,1-dichloroethane, methylene chloride, tetrachloroethene, and trichloroethene. Laboratory microcosm studies demonstrated that all these pollutants could be biodegraded using a sequential aerobic—anaerobic treatment process. However, during the aerobic phase, the pH dropped to 5 or less, slowing biodegradation.

Biodegradation processes could be enhanced at the site by injecting a Mg(OH)₂ suspension with a mean particle size less than the pore size of the sediment to increase the pH of the aquifer to between 7 and 8. Oxygen could then be supplied by a variety of different processes including injection of solid oxygen releasing materials (calcium or magnesium peroxide), recirculation of aqueous solutions containing dissolved oxygen or hydrogen peroxide, air sparging, or dewatering followed by bioventing. Once the aerobically biodegradable contaminants were reduced, anaerobic biodegradation processes could be enhanced by injection of liquid organic substrates or emulsified oils.

### Example 3

### pH Adjustment for Enhanced Attenuation at a Petroleum Release

Common groundwater contaminants associated with gasoline and other petroleum releases include benzene, toluene, ethylbenzene, xylenes (BTEX), 1,2,4- and 1,3,5-trimethylbenzene, n-butylbenzene, n-propylbenzene and naphthalene. All of these compounds are known to be readily biodegradable under aerobic and/or anaerobic conditions (Borden, 1994). Numerous laboratory and field studies have shown that these contaminants can biodegrade without human intervention through a process termed “Natural Attenuation”. However, low pH conditions can slow or stop natural attenuation.

Natural attenuation processes could be enhanced by injecting a low solubility alkaline solid into the aquifer to increase the pH providing conditions more suitable for petroleum hydrocarbon biodegradation. As the solid slowly dissolves over time, it would provide a long term source of alkalinity to maintain a neutral or slightly alkaline pH and enhance biodegradation processes. Sufficient alkaline solid would be injected to last the entire life of the groundwater plume eliminating the need for any further treatment. The alkaline solid would be prepared as an aqueous suspension with a mean particle size less than the pore size of the aquifer material and would be injected into a series of permanent or temporary wells. These wells could be located within the contaminant source area or in a barrier configuration, intersecting the contaminant plume perpendicular to groundwater flow.

### Example 4

### Metals Immobilization in Source Areas and Barriers

A variety of metals including iron (Fe), manganese (Mn), titanium (Ti), vanadium (Va) chromium (Cr), cobalt (Co), nickel (Ni), molybdenum (Mo), copper (Cu), silver (Si), zinc (Zn), cadmium (Cd), mercury (Hg), and lead (Pb) may be present in groundwater at undesirable levels. These material may enter groundwater from a variety of sources including metal working operations, acid mine drainage, dissolution of natural minerals and numerous other sources. These metals are most mobile under low pH, acidic condition. However, at neutral to basic pH, these metals can be removed from solution through formation of insoluble metal hydroxides, metal carbonates and/or sorption onto metal oxide surfaces. As a result, the mobility and hazard associated with these metals can be reduced by adding alkaline solids to increase the pH and provide a long term source of alkalinity to maintain an elevated pH.

Source areas above and below the water table can be treated by preparing an aqueous suspension of Ca(OH)₂ with a mean particle size less than the mean pore size of the sediment. The suspension is amended with xanthan gum and sodium carboxymethylcellulose to increase the dispersed phase viscosity to between 3 and 10 centipoise. This increase in viscosity is sufficient to prevent rapid settling of the Ca(OH)₂ particles while maintaining a viscosity sufficiently low to allow easy injection into most geologic formations. The aqueous suspension is then passed three times through a high pressure homogenizer at a pressure of 2500 psi to deflocculate the suspension. The suspension is then injected into the subsurface through a series of temporary or permanent injection wells.

The amount of water to be injected is based on the dimensions of the treatment zone and the effective porosity of the formation. The amount of Ca(OH)₂ to be injected is selected by the following process. First, the target pH of the remediation process is selected to reduce the metal concentration to acceptable levels due to precipitation of insoluble metal hydroxides and enhanced sorption to naturally occurring minerals. Second, groundwater and formation samples are titrated with NaOH to determine the milliequivalents of base required to reach the target pH. Third, the milliequivalents of NaOH is converted to the amount of Ca(OH)₂ required. Additional Ca(OH)₂ should be provided to account for acidity carried into the treatment zone over the design life of the treatment process. The ratio of Ca(OH)₂ to water is commonly between 1:100 and 1:10. However, ratios outside this range may be required depending on the acidity of the water and geologic material. There are a variety of modifications that can be used to enhance the effectiveness of the approach described above including injection of a mixture of hydroxides (Ca(OH)₂ and Mg(OH)₂) and carbonates (NaHCO₃, CaCO₃ and MgCO₃).

Dissolved plumes of groundwater containing undesirable levels of metals can be treated in situ through formation of a permeable reactive barrier. In this approach, a line of temporary or permanent wells are installed perpendicular to groundwater flow and extending across the plume. A suspension of alkaline solids and water is injected through each well. The alkaline solids are transported away from the well by the flowing water and are distributed throughout the formation resulting in a zone of elevated pH. As groundwater flows through this elevated pH zone, the metals precipitate as insoluble metal hydroxides, carbonates or are sorbed to the surfaces of naturally occurring minerals. The amount of water injected is selected to distribute the suspension throughout the required radius of influence around the injection well. The amount of alkaline solids is selected to adjust the pH of the geologic formation and any groundwater that flows through the barrier of the design life of the system.

### Example 5

### High pH Activated Chemical Oxidation

A wide variety of organic chemical contaminants can be treated in situ using persulfate in combination with high pH including chlorinated ethenes, ethanes, and methanes, mono- and polynuclear aromatic hydrocarbons, oxygenates, petroleum hydrocarbons, chlorobenzenes, phenols, pesticides, herbicides, ketones and polychlorinated biphenyls (FMC, 2006; Block et al., 2006, US Patent Application 20060054570). However, achieving a high pH in the subsurface can be difficult due to the strong buffering capacity of many subsurface materials.

Contaminated subsurface zones could be treated using a two stage process. First, an aqueous suspension of Ca(OH)₂ with a mean particle size less than the mean pore size of the sediment would be distributed throughout the treatment zone. Sufficient Ca(OH)₂ would be injected to increase the pH to at least 10.5. Next, a solution containing monopersulfates and/or dipersulfates is distributed using the same wells. The high pH generated by the Ca(OH)₂ activates the persulfate resulting in formation of sulfate radicals with rapidly oxidize the target pollutants. If contaminant concentrations rebound over time, additional persulfate can be injected without the need to add additional Ca(OH)₂.

### Example 6

### In Situ Formation of Metal Peroxide Treatment Zones

Looney et al. (2007, U.S. Pat. No. 7,160,471) describes a method for in situ creation of metal peroxides where naturally occurring or anthropogenic alkaline earth metals are treated with energetic oxidizing free radicals. The metal peroxides then slowly decompose over time releasing oxygen to stimulate aerobic biodegradation processes and/or maintain oxidizing conditions to immobilize certain metals (Koenigsberg et al., 1993, U.S. Pat. No. 5,264,018).

In situ treatment zones could be created using an enhancement of the approach described by Looney et al. (2007) where an aqueous suspension of Ca(OH)₂ with a mean particle size less than the mean pore size of the sediment is first distributed throughout the treatment zone to increase the pH to at least 10.5. Next, a solution containing monopersulfates and/or dipersulfates is distributed using the same wells. The high pH generated by the Ca(OH)₂ activates the persulfate resulting in formation of sulfate radicals. These sulfate radicals oxidize the Ca(OH)₂ and other alkaline earth materials resulting in the formation of metal peroxides and other oxidized minerals. These metals peroxides and oxidized minerals then provide a long term source of oxygen enhancing aerobic biodegradation processes and immobilizing certain metals. An important advantage of this process over the invention of Looney et al. (2007) is that the high pH provided by the Ca(OH)₂ reduces the rate of metal peroxide decomposition, increasing the operating life of the treatment zone.

Having thus described the invention the same will become better understood from the appended claims in which it is set forth on a non-limiting manner.

What is claimed is:

1. A method for increasing the pH of subsurface material comprising:
distributing a solid alkaline material into the subsurface material, said solid alkaline material formulated into a suspension where the average particle size of the suspension is less than the average pore size or fracture aperture of the subsurface material, and said distribution of solid alkaline material being done in an amount effective to increase the pH of the subsurface material to a selected level.

2. The method according to claim 1, wherein the subsurface materials contains contaminants which are at least one of organic and inorganic compounds, wherein the contaminants are biodegraded by adjusting the treatment zone pH to a value which enhances biodegradation.

3. The method according to claim 1, wherein the subsurface materials contain contaminants which are at least one of inorganic compounds, including metals and radionuclides, wherein contaminant mobility may be reduced by adjusting the treatment zone pH to a range effective to reduce contaminant mobility.

4. The method according to claim 1, further comprising enhancing the transport characteristics of the suspension are by adding chemical agents in amounts effective to control particle surface charge and degree of flocculation in the suspension.

5. The method according to claim 4, wherein the chemical agents are selected from the group consisting of chemical agents including anionic, cationic, nonionic, and amphoteric/zwitterionic surfactants and coagulants.

6. The method according to claim 1, further comprising controlling settling of the solid alkaline material by adding an amount of chemical agents effective to increase the suspension viscosity.

7. The method according to claim 6, wherein the chemical agents are selected from the group consisting of agar, lignin, alginates, arrowroot, carageenan, collagen, cornstarch, fecula, gelatin, glycerol, katakuri, pectin, tapioca, Arabic gum, guar gum, locust bean gum, xanthan gum, starch derivatives and cellulose derivatives.

8. The method according to claim 1, wherein the solid alkaline material is selected from the group consisting of MgO, Mg(OH)₂, MgCO₃, CaO, Ca(OH)₂, and CaCO₃.

9. The method according to claim 1, wherein the suspension of solid alkaline material is amended by adding at least one of liquid and dissolved alkaline materials including NaOH, Na₂CO₃, NaHCO₃, NH₄OH, (NH₄)₂CO₃, Na₅P₃O₁₀, Na₂HPO₄ and Na₃PO₄.

10. The method according to claim 1, wherein the suspension is prepared from a mixture of solid and liquid alkaline materials.

11. The method according to claim 8, wherein the solid alkaline material is magnesium hydroxide with an average particle size less than 5 microns (<5 μm).

12. The method according to claim 1, wherein the suspension of solid alkaline material is amended by adding electron donors, including solid and/or liquid materials, to enhance anaerobic biodegradation processes.

13. The method according to claim 12, wherein the solid and/or liquid materials include short, medium and long-chain fatty acids, sugars, carbohydrates, proteins, solid fats, liquid oils, emulsified fats and oils, and other biodegradable organic substrates.

14. The method according to claim 12, wherein the solid and/or liquid materials are a mixture of lactate, lactic acid and emulsified vegetable oil.

15. The method according to claim 1, wherein the suspension of solid alkaline material is amended by adding microbial growth factors, including inorganic nutrients, vitamins, trace minerals, and amino acids, for enhancing contaminant biodegradation.

16. The method according to claim 1, wherein the suspension of solid alkaline material is amended by adding electron acceptors including peroxides, nitrates, nitrites, and/or sulfates to enhance contaminant biodegradation.

17. The method according to claim 1, wherein the suspension of solid alkaline material is amended by adding chemical oxidants including hydrogen peroxide, metal peroxides, peroxygens, persulfates, permanganate, and other oxidizing compounds to enhance contaminant degradation.

18. The method according to claim 1, wherein the suspension of solid alkaline material is amended by adding chemical reductants including reactive metals, monosulfides, polysulfides, dithionites and other reducing compounds for enhancing contaminant degradation.

19. The method according to claim 1, wherein the suspension of solid alkaline material is amended by adding chemical stabilizing agents including phosphates, chemical oxidants and chemical reductants for reducing contaminant mobility.

20. The method according to claim 1, wherein the contaminant is present in unconsolidated material or fractured rock above or below the water table and is treated by distributing the suspension throughout a selected treatment zone to effect an increase in pH in this zone.

21. The method according to claim 1, wherein groundwater is treated by distributing alkaline solids to form a permeable reactive barrier (PRB) perpendicular to flow to increase the pH of groundwater as it passes through the barrier.
